(19) United States
(12) Patent Application Publication
(10) Pub. No.: US 2010/0151151 A1
(43) Pub. Date: Jun. 17, 2010

(54) METHOD OF FORMING LOW-K FILM HAVING CHEMICAL RESISTANCE

(75) Inventors: Kiyohiro Matsushita, Tokyo (JP); Akinori Nakano, Tokyo (JP); Ryo Kawaguchi, Tokyo (JP); Yuya Nonaka, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: ASM JAPAN K.K., Tokyo (JP)

(21) Appl. No.: 12/333,186

(22) Filed: Dec. 11, 2008

(51) Int. Cl. B05D 5/12

(52) U.S. Cl. 427/578

(57) ABSTRACT

A method of forming a low-k film containing silicon and carbon on a substrate by plasma CVD, includes: supplying gas of a precursor having a Si—R—O—R—Si bond into a reaction space in which a substrate is placed; and exciting the gas in the reaction space, thereby depositing a film on the substrate.

### BACKGROUND

1. Field of the Invention

The present invention generally relates to a method of forming a low-k (low dielectric constant) film on a substrate, particularly to a method of forming a low-k film containing silicon and carbon and having high resistance to chemical processing, by plasma enhanced chemical vapor deposition (PECVD).

2. Description of the Related Art

As the rules of device design change to accommodate smaller sizes, the dielectric constants between inter-layer insulation films are also becoming lower. The acceleration of the trend for finer wirings is pushing the dielectric constant levels required of devices in the 65-nm and 45-nm generations down to 2.6 or even lower, although the specific requirements vary depending on the device manufacturer. However, lowering the dielectric constant significantly affects the mechanical strength of the film as well as the resistance to peripheral technologies. Because of this, the UV curing process is receiving the attention for the primary reason that this process can improve the mechanical strength by approx. 20 to 100% in a condition where an increase in dielectric constant is kept to a minimum. On the other hand, studies are finding that UV curing leads to loss of CHx in the film and consequent lowering of its chemical resistance. Since low-k films are exposed to chemical reactions through etching, resist ashing, wet cleaning, etc., in the wiring process, if their chemical resistance is low the processed shape may be affected or the dielectric constant may rise due to moisture absorption, etc. To solve these problems, one effective way is to select a base material containing a large amount of carbon to increase the content of carbon in the achieved film. However, simply increasing the content of carbon will lead to decrease in mechanical strength, and thus how carbon is added to the film structure becomes important.

With SiOC low-k films, the void ratio in the film must be increased to lower the dielectric constant. However, doing so also causes the mechanical strength to drop. UV curing is considered a promising technology to solve this problem. However, it has been reported that UV curing causes —CH₃ and other substitution groups bounded to Si to break down, thereby lowering the content of carbon in the film. The content of carbon in the low-k film has significant impact on the chemical resistance of the film. If the content of carbon is low, the film will be damaged when it is exposed to chemical reactions through etching, resist ashing, wet cleaning, etc., in the wiring process, and the processed shape may be affected or the dielectric constant may rise due to moisture absorption, etc.

On the other hand, various ideas have been examined regarding the solution of adding CHx to the film in order to increase the chemical resistance of the film. For example, the inventors evaluated a film structure where the substitution groups bonded to Si have a larger carbon size (such as Comparative Example 3 explained later). However, these substitution groups cause the mechanical strength to drop as the dielectric constant decreases, and thus the mechanical strength must be improved by UV curing. In addition, these substitution groups are easily broken down as a result of UV curing, which makes it difficult to achieve high carbon content and high strength at the same time.

### SUMMARY

At least one embodiment of the present invention solves at least one of the aforementioned problems by forming a film where Si and Si in the base structure are cross-linked by C—O—C. The Si-Cn-O-Cn-Si structure can achieve a lower dielectric constant while keeping the mechanical strength. Also, the mechanical strength can be increased while keeping the breakdown as a result of UV curing to a minimum and also while suppressing the drop in carbon content. As a result, a low-k film containing a lot of carbon and having high chemical resistance and high strength can be achieved. RBS-HFS analysis results have shown that the content of carbon is approx. 10 to 18% with a conventional film, while it increases to 20% or more, or even to approx. 25%, in an embodiment of the present invention. In an embodiment of the present invention, high strength and high chemical strength can be achieved when the specific dielectric constant of the film is 2.7 or less (such as 2.2 to 2.7), or 2.6 or less (such as 2.0 to 2.6).

Because of the above, in an embodiment a precursor having the structure of Si—R—O—R—Si is used to incorporate Si-Cn-O-Cn-Si bonds into the film. The resulting film contains a lot of carbon and thus a high content of carbon can be maintained in the film even when UV curing is applied subsequently.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are oversimplified for illustrative purposes and are not necessarily to scale.

FIG. 1 is a schematic view illustrating a plasma CVD apparatus usable in an embodiment of the present invention.

FIG. 2 is a schematic view illustrating a UV curing apparatus usable in an embodiment of the present invention.

FIG. 3 is a schematic view illustrating a thermal annealing apparatus usable in an embodiment of the present invention.

### DETAILED DESCRIPTION

Embodiments of the present invention will be explained below. The present invention are not limited to the disclosed embodiments.

An embodiment includes a method of forming a low-k film containing silicon and carbon on a substrate by plasma CVD, comprising:

(i) supplying gas of a precursor having a Si—R¹—O—R²—Si bond in its molecule wherein R¹ and R² are hydrocarbon, into a reaction space in which a substrate is placed; and

(ii) exciting the gas in the reaction space, thereby depositing a film on the substrate.

In an embodiment, the precursor may have the following formula:

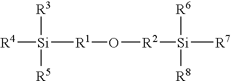

wherein R¹ and R² are each independently a C1-6 hydrocarbon; and R³ to R⁸ are each independently hydrogen, a C1-4 alkyl group, or a C1-4 alkoxyl group, proviso that at least one of R³ to R⁵ and at least one of R⁶ to R⁸ are C1-4 alkoxyl groups.

In an embodiment, R¹ and R² may each be a C1-4 alkylene group. In an embodiment, the C1-4 alkylene group may be —(CH₂)ₙ— wherein n is 1, 2, or 3.

In another embodiment, R¹ and R² may each be a C1-4 alkenylene group. In an embodiment, the C1-4 alkenylene group may be —CₙH₂ₙ₋₂— wherein n is 2 or 3.

In still another embodiment, R¹ and R² may each be a phenylene.

In any of the foregoing embodiment, preferably, R¹ and R² are the same.

In any of the foregoing embodiments, R³ to R⁸ may each be a methyl group, ethyl group, methoxyl group, or ethoxyl group, and at least one of R³ to R⁵ and at least one of R⁶ to R⁸ are each a methoxyl group or ethoxyl group.

In any of the foregoing embodiments, the precursor gas may be supplied at a flow rate of 0.2 to 2.0 g/min (including 0.3 to 0.8 g/min). The precursor may be liquid at room temperature and before supplying it to the reaction space the precursor is vaporized. Any suitable vaporizer and vaporizing technology can be used for that purpose. The flow rate may be adjusted according to the characteristics of the precursor, such as flowability, boiling temperature, etc. The precursor may have a boiling point of 150 to 250° C. in an embodiment.

The precursor can be used singly or in combination of two or more. In an embodiment, the precursor is the only reactive process gas or precursor.

In any of the foregoing embodiments, the method may further comprise supplying an inert gas such as He, Ar, Kr, or Xe to the reaction space in addition to the precursor gas. In an embodiment, the inert gas may be supplied at a flow rate of 100 to 1,000 sccm (including 150 to 600 sccm). The above inert gas can also be used as a carrier gas to supply the vaporized precursor to the reaction space.

In any of the foregoing embodiments, the method may further comprise supplying an additive gas such as hydrogen gas and a hydrocarbon gas in addition to the precursor gas. In another embodiment, no additive gas is supplied. In an embodiment, the hydrocarbon gas may be supplied at a flow rate of 0.1 to 3 g/min (including 0.5 to 2 g/min). The hydrocarbon gas may be one or more compounds selected from the group consisting of CₙH₂ₙ₊₂ wherein n is an integer of 1 to 5, CₙH₂ₙ wherein n is an integer of 1 to 5, and CₙH₂ₙ₊₁OH wherein n is an integer of 1 to 5.

In any of the foregoing embodiments, the method may further comprise supplying gas of a siloxane precursor, such as diethylmethylsiloxane (DEMS) and dimethyldimethoxysiloxane (DMDMOS), in addition to the precursor gas. In an embodiment, the siloxane precursor gas may be supplied at a flow rate of 0.1 to 1.0 g/min (including 0.3 to 0.8 g/min).

In any of the foregoing embodiments, the method may further comprise curing the film deposited on the substrate. The curing may be accomplished by UV treatment or heat treatment. In an embodiment, the above method may further comprise subjecting the cured film to etching, ashing, or wet cleaning. The film obtained by any of the foregoing embodiments may be relatively chemically inert, or have high resistance to chemical processing, and thus, the film may be suitable for any treatment process using a chemical. Further, the depositing film on the substrate may have a dielectric constant of less than 2.7 (e.g., 2.2 to 2.7 or 2.0 to 2.6).

In an embodiment, the content of carbon in the film can be increased to 20% or more, or even to approx. 25%, in order to achieve a low-k film offering high chemical strength. Also, use of a material in which Si and Si are bonded by (C)n-O—(C)ₙ also allows for achievement of high strength (of 4 to 5 GPa in an embodiment). This material contains Si—(C)n-O—(C)n-Si bonds and R—O—Si bonds, and the film created from this material can exhibit high strength because the reduction of carbon is small even after UV curing.

In any of the foregoing embodiments, the gas may be excited with a plasma. Preferably, plasma enhanced chemical vapor deposition (PECVD) can be used.

For example, forming of a film on a semiconductor substrate by PECVD is implemented by placing the semiconductor substrate, which is the processing target, on a heater of resistance heating type, etc., that has been heated to a temperature of 0 to 400° C. in an atmosphere of 1 to 10 Torr. The heater is installed in a manner facing a shower plate that releases reactant gas, and a high-frequency power of 13.56 to 60 MHz, etc., is applied by 100 to 4000 W to the shower plate to implement plasma discharge between the heater and shower plate. A thin film can be formed using SiOC low-k material, which is a silicon-based insulation film forming material, additive gases such as CO₂ and O₂, and HC-type gas such as alcohol. As for the inert gas not resulting directly from chemical reaction, Ar, He, Kr or Xe is used. The introduced process gases are broken down by the aforementioned discharge to form a thin film on the semiconductor substrate. For your reference, a summary of conditions in an embodiment is given below.

(1) Material gas flow rate: 0.2 to 2.0 g/min or 0.8 to 1.5 g/min

(2) Inert gas flow rate: 100 to 1000 sccm (He) or 150 to 300 sccm (He)

(3) Oxidizing gas flow rate: None

(4) Reducing gas flow rate: None

(5) Additive gas (CH-based) flow rate: 0.1 to 3 g/min (ATRP)

(6) Other gas that can be added: Cyclohexane, etc.

(7) Flow rate of siloxane material that can be added: 0.1 to 1.0 g/min sccm (gas type: DEMS)

(8) Mixing ratio of aforementioned siloxane material and applicable material: 0.1 to 0.9

(9) Film forming speed: 50 to 500 nm/min

(10) Film forming temperature: 200 to 300° C.

(11) Film pressure: 100 to 900 Pa

(12) RF frequency: 27 MHz (13 MHz or more)

(13) RF output: 500 to 3000 W

In an embodiment, general conditions for curing are set as follows, for example:

(1) UV power: 100 to 500 mW/cm² (The specific power varies depending on the lamp type and is also affected by the specific wavelength. Accordingly, an appropriate power level should be selected as deemed appropriate even outside the range.)

(2) Temperature: 300 to 450° C.

(3) Pressure: 1 to 760 Torr

(4) Processing time: 60 to 2000 sec (at a film thickness of 500 nm)

(5) Gas flow rate: 2 to 10 slm (N₂, He or other inert gas)

(6) Additive gas: H₂, O₂, CO₂

An apparatus that can be used in an embodiment of the present invention is explained below.

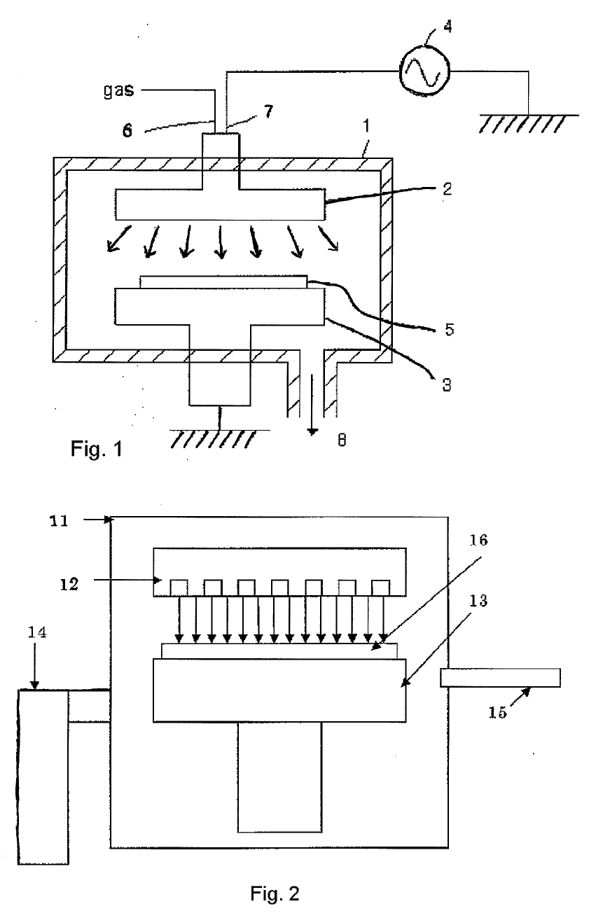

FIG. 1 shows a plasma CVD apparatus usable in an embodiment of this invention. The plasma CVD device includes reaction chamber 1, a gas inlet port 6 and a susceptor 3 (serving as a lower electrode) provided with an embedded temperature controller, which can be a coil in which a coolant or heating medium flows in a channel to control the temperature of the susceptor 3. A semiconductor substrate 5 is shown overlying the susceptor 3. A showerhead 2 (serving as an upper electrode) may be disposed immediately under the gas inlet port. The showerhead 2 has a number of fine openings at its bottom face and can inject reaction gas to the semiconductor substrate 5 therefrom. There is an exhaust port 8 at the bottom of the reaction chamber 1. This exhaust port 8 is connected to an outer vacuum pump (not shown) so that the inside of the reaction chamber 1 can be evacuated. The susceptor 3 is placed in parallel with and facing the showerhead 2. The susceptor 3 holds the semiconductor substrate 5 thereon and heats or cools it with the temperature controller. The gas inlet port 6 is insulated from the reaction chamber 1 and connected to an outer high frequency power supply 4. Alternatively, the susceptor 3 can be connected to the power supply 4. Thus, the showerhead 2 and the susceptor 3 can each act as a high frequency electrode and generate a plasma reacting field in proximity to the surface of the semiconductor substrate 5.

For embodiments supplying multiple process gases, the gases can be mixed upstream of the gas inlet port 6 to constitute a process gas, or each or some of the gases can be introduced separately into the showerhead 2. The space between the showerhead 2 and the semiconductor substrate 5, located inside of the reaction chamber 1 which is already evacuated, is charged with RF power which has a single frequency or mixed frequencies (e.g., 13.56 MHz to 60 MHz), and the space serves as a plasma field. The susceptor 3 continuously heats or cools the semiconductor substrate 5 with the temperature controller and maintains the substrate 5 at a predetermined temperature that is desirably in the range of about −50° C. to +50° C. The process gas supplied through the fine openings of the showerhead 2 remains in the plasma field in proximity to the surface of the semiconductor substrate 5 for a predetermined time.

When the insulation film is deposited on the substrate by PECVD, the gas inside the reaction chamber is discharged through the exhaust port 8 and replaced with a reducing gas or a mixture of a reducing gas and an inert gas, while maintaining the substrate in the reaction chamber.

The temperature of the susceptor 3 can be controlled by means of a heater and/or cooling conduits (now shown). This cooling susceptor may be made of ceramics and is provided with the cooling conduits at a lower portion of a metal plate and a shaft portion so that a cooling medium such as water can circulate.

The additive gas comprises an inert gas, oxidizing gas or reducing gas or any combination thereof. The inert gas may be He, Ar, Kr or Xe or any combination thereof. Since these gases have varying ionization energy and collision cross-section, changing the combination of these gases allows for control of the reaction in gas phase. A desired additive gas composition can be selected according to the purpose from the group consisting of hydrogen (H₂), CₙH₂ₙ₊₂ (n is an integer of 1 to 5), CₙH₂ₙ (n is an integer of 1 to 5), CₙH₂ₙ₊₁OH (n is an integer of 1 to 5) and any combination thereof. If a hydrogen-based additive gas is used in a large quantity, the thermal stability of the film tends to decrease. Accordingly, caution needs to be exercised regarding the mixing ratio of process gases. Mixing other siloxane material is also effective, where DEMS, DMDMOS, etc., can be used.

In an embodiment, subsequently, a curing process is performed on the semiconductor substrate taken out from the reactor using, e.g., the UV cure apparatus shown in FIG. 2. The UV cure apparatus comprises a process chamber 11, a UV lamp 12, a susceptor 13, an exhaust port 14, and a gas inlet port 15. The UV lamp 12 and the susceptor 13 are disposed parallel to each other, and are heated by heaters embedded in each of them. The semiconductor substrate 16, which is a workpiece, is placed on the susceptor 13 and is heated and held. Projected from the UV lamp 12, light having a wavelength selected from the range of 172 to 250 nm is irradiated toward the semiconductor substrate 16. When the semiconductor substrate is irradiated with this light, gases such as He, H₂, N₂, O₂, CO₂, etc. (depending on the intended type of film) are introduced through the gas inlet port 15 simultaneously with the irradiation. As pores are formed in the film, with H, O, C, etc. being desorbed from a low-dielectric-constant film on the substrate 16, the number of unstable bonds in the structure are reduced; hence, a film having a lower dielectric constant and higher strength can be obtained.

Further details of the UV cure apparatus disclosed in U.S. Patent Publication No. 2006-0165904 can be used in an embodiment, the disclosure of which is incorporated herein by reference in its entirety with regard to the UV cure apparatus.

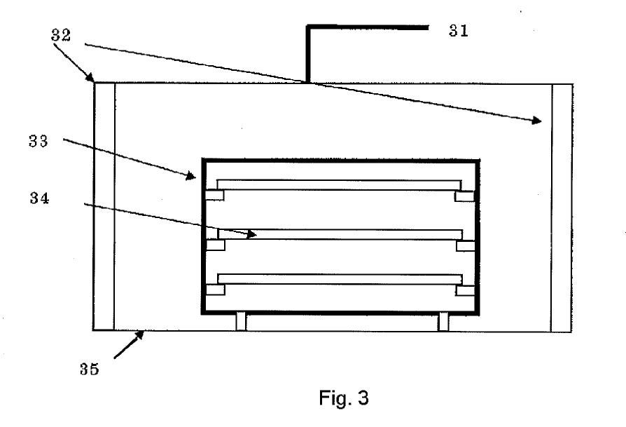

The heat-treating step can be performed by thermal annealing in place of the UV curing. FIG. 3 shows a schematic diagram of a thermal annealing apparatus. In a chamber 35, a quartz boat 33 is provided, and one or more substrate(s) 34 is/are placed inside the quartz boat 33. The temperature inside the quartz boat 33 is controlled by a heater 32, and gases can be introduced inside through a gas inlet port 31.

The chemical resistance of the film can be evaluated, for example, by wet etch evaluation conducted as follows: After a film is deposited on a substrate and subjected to curing, the substrate with the film is cut into strips (e.g., 4 to 5 cm in width) and then submerged in a liquid such as an undiluted liquid of LAL500 (manufactured by Stella-Chemifa in Japan) at 50° C. for 10 minutes. Thereafter, the thickness of the film is measured.

The skilled artisan will appreciate that the apparatus includes one or more controller(s) (not shown) programmed or otherwise configured to cause the deposition and reactor cleaning processes described elsewhere herein to be conducted. The controller(s) communicate with the various power sources, heating systems, pumps, robotics and gas flow controllers or valves of the reactor, as will be appreciated by the skilled artisan.

In the present disclosure where conditions and/or structures are not specified, the skilled artisan in the art can readily provide such conditions and/or structures, in view of the present disclosure, as a matter of routine experimentation. Also, in the present disclosure, the numerical numbers applied in specific embodiments can be modified by a range of at least 50% in other embodiments, and the ranges applied in embodiments may include or exclude the endpoints.

### EXAMPLE

Experiments were conducted as described below. The results are indicated in tables below. In the tables, a downward pointing arrow indicates that the immediately overlying entry is carried over to the box containing the arrow. In these experiments, a plasma CVD apparatus (Eagle® 12, ASM Japan) shown in FIG. 1 was used. An insulation film was formed on a Si wafer (300 mm). UV treatment was conducted in the UV treatment apparatus shown in FIG. 2.

It is difficult to form a film stably under the exact same conditions using different materials, and to evaluate the performance achievable by a given set of materials the film forming conditions need to be optimized according to the applicable materials. In the examples explained below, the conditions are adjusted to align the dielectric constant and Young's modulus (EM).

### Comparative Example 1

### Comparative Process

In Comparative Example 1, materials containing carbon and silicon and not bonded by oxygen (DEMS, ATRP) were used.

Film Forming Conditions:

Susceptor temperature: 250° C.

DEMS flow rate: 0.48 g/min

ATRP (α-terpinene) flow rate: 0.72 g/min

He flow rate: 1000 sccm

Output at 13.56 MHz: 700 W

Film forming pressure: 880 Pa

Characteristics of Formed Film:

Dielectric constant: 2.75

Modulus: 6 GPa

Film stress: 35 MPa

UV Curing Process:

Wavelength: 200 to 400 nm, 160 mW/cm²-λ 365 nm, susceptor temperature: 400° C., N₂: 4 SLM, pressure: 5 Torr, time: 300 sec

Film Characteristics After Curing:

Dielectric constant: 2.60

Film shrinkage: 14%

Modulus: 9 GPa

Film stress: 65 MPa (tensile)

Etching rate with amine cleaning agent: 15 nm/min

### Comparative Example 2

### Comparative Process

In Comparative Example 2, siloxane (DMOTMDS) was used as the material.

Film Forming Conditions:

Susceptor temperature: 250° C.

DMOTMDS (dimethoxy tetramethyl disiloxane)/(CH₃O)(CH₃)₂SiOSi(CH₃)₂(CH₃₀) flow rate: 1.5 g/min

He flow rate: 400 sccm

Output at 27 MHz: 900 W

Film forming pressure: 900 Pa

Characteristics of Formed Film:

Dielectric constant: 2.80

Modulus: 3 GPa

Film stress: 30 MPa

UV Curing Process:

Wavelength: 200 to 400 nm, 160 mW/cm²-λ 365 nm, susceptor temperature: 400° C., N₂: 4 SLM, pressure: 5 Torr, time: 300 sec

Film Characteristics After Curing:

Dielectric constant: 2.65

Film shrinkage: 15%

Modulus: 7 GPa

Film stress: 50 MPa (tensile)

Etching rate with amine cleaning agent: 4 nm/min

### Comparative Example 3

### Comparative Process

In Comparative Example 3, diisopropyl dimethoxy silane/(i-C₃H₇)₂(CH₃O)₂Si, which has many carbon molecules bonding with Si and also has many Si—O bonds, was used as the material.

Film Forming Conditions:

Susceptor temperature: 250° C.

Diisopropyl dimethoxy silane/(i-C₃H₇)₂(CH₃O)₂Si flow rate: 1.6 g/min

He flow rate: 400 sccm

Output at 27 MHz: 1000 W

Film forming pressure: 800 Pa

Characteristics of Formed Film:

Dielectric constant: 2.89

Modulus: 5 GPa

Film stress: 30 MPa

UV Curing Process:

Wavelength: 200 to 400 nm, 160 mW/cm²-λ 365 nm, susceptor temperature: 400° C., N₂: 4 SLM, pressure: 5 Torr, time: 120 sec

Film Characteristics After Curing:

Dielectric constant: 2.65

Film shrinkage: 14%

Modulus: 8 GPa

Film stress: 85 MPa (tensile)

Etching rate with amine cleaning agent: >50 nm/min

### Example 1

Example 1 provides an example of the present invention, where a material with a Si—R—O—R—Si bond (3,3-(bismethoxydimethylsilyl)propyl ether) was used.

Film Forming Conditions:

Susceptor temperature: 250° C.

3,3-(bismethoxy dimethyl silyl)propyl ether/(CH₃O)(CH₃)₂Si—(CH₂)₃—O—(CH₂)₃Si(CH₃)₂(CH₃O) flow rate: 1.4 g/min

He flow rate: 180 sccm

Output at 27 MHz: 2000 W

Film forming pressure: 600 Pa

Characteristics of Formed Film:

Dielectric constant: 2.85

Modulus: 4 GPa

Film stress: 30 MPa

UV Curing Process:

Wavelength: 200 to 400 nm, 160 mW/cm²-λ 365 nm, susceptor temperature: 400° C., N₂: 4 SLM, pressure: 5 Torr, time: 360 sec

Film Characteristics After Curing:

Dielectric constant: 2.57

Film shrinkage: 30%

Modulus: 7.0 GPa

Film stress: 65 MPa (tensile)

Etching rate with amine cleaning agent: 0.1 to 0.3 nm/min

### Example 2

Example 2 provides an example of the present invention, where a material with a Si—R—O—R—Si bond (3,3-(bisdimethoxymethylsilyl)propyl ether) was used.

Film Forming Conditions:

Susceptor temperature: 250° C.

3,3-(bisdimethoxy dimethyl silyl)propyl ether/(CH₃O)₂(CH₃)Si(CH₂)₃—O—(CH₂)₃Si(CH₃)(CH₃O)₂ flow rate: 1.4 g/min

He flow rate: 500 sccm

Output at 27 MHz: 600 W

Film forming pressure: 600 Pa

Characteristics of Formed Film:

Dielectric constant: 2.85

Modulus: 4 GPa

Film stress: 30 MPa

UV Curing Process:

Wavelength: 200 to 400 nm, 160 mW/cm²-λ 365 nm, susceptor temperature: 400° C., N₂: 4 SLM, pressure: 5 Torr, time: 360 sec

Film Characteristics After Curing:

Dielectric constant: 2.60

Film shrinkage: 27%

Modulus: 7.0 GPa

Film stress: 65 MPa (tensile)

Etching rate with amine cleaning agent: 0.7 to 0.8 nm/min

As evident from the above, Examples 1 and 2 where the material contained a Si—R—O—R—Si bond achieved films whose specific dielectric constant was 2.6 or less and whose chemical resistance was amazingly high. The etching rates of these films were not more than 1/20th to 1/150th the etching rate of the film obtained in Comparative Example 1 where a Si-containing hydrocarbon material not containing 0 was used, not more than ⅕th to 1/40th the etching rate of the film obtained in Comparative Example 2 where a hydrocarbon material containing a Si—O—Si bond was used, and not more than 1/60th to 1/500th the etching rate of the film obtained in Comparative Example 3 where a hydrocarbon material with a higher carbon number and containing a Si—O bond was used. These results were indeed amazing numbers.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A method of forming a low-k film containing silicon and carbon on a substrate by plasma CVD, comprising:
supplying gas of a precursor having a Si—R¹—O—R²—Si bond in its molecule wherein R¹ and R² are hydrocarbon, into a reaction space in which a substrate is placed; and
exciting the gas in the reaction space, thereby depositing a film on the substrate.

2. The method according to claim 1, wherein the precursor has the following general formula: 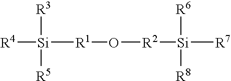
wherein R¹ and R² are each independently a C1-6 hydrocarbon, and R³ to R⁸ are each independently hydrogen, a C1-4 alkyl group, or a C1-4 alkoxyl group, proviso that at least one of R³ to R⁵ and at least one of R⁶ to R⁸ are C1-4 alkoxyl groups.

3. The method according to claim 2, wherein R¹ and R² are each a C1-4 alkylene group.

4. The method according to claim 3, wherein the C1-4 alkylene group is —(CH₂)ₙ— wherein n is 1, 2, or 3.

5. The method according to claim 2, wherein R¹ and R² are each a C1-4 alkenylene group.

6. The method according to claim 5, wherein the C1-4 alkenylene group is —CₙH₂ₙ₋₂— wherein n is 2 or 3.

7. The method according to claim 2, wherein R¹ and R² are each a phenylene.

8. The method according to claim 2, wherein R³ to R⁸ are each a methyl group, ethyl group, methoxyl group, or ethoxyl group, and at least one of R³ to R⁵ and at least one of R¹ to R⁸ are each a methoxyl group or ethoxyl group.

9. The method according to claim 1, wherein the precursor gas is supplied at a flow rate of 0.2 to 2.0 g/min.

10. The method according to claim 1, wherein the gas is excited with a plasma.

11. The method according to claim 1, further comprising supplying an inert gas to the reaction space in addition to the precursor gas.

12. The method according to claim 11, wherein the inert gas is supplied at a flow rate of 100 to 1,000 sccm.

13. The method according to claim 1, further comprising supplying hydrogen gas or a hydrocarbon gas in addition to the precursor gas.

14. The method according to claim 13, wherein the hydrocarbon gas is supplied at a flow rate of 0.1 to 3 g/min.

15. The method according to claim 1, further comprising supplying gas of a siloxane precursor in addition to the precursor gas.

16. The method according to claim 15, wherein the siloxane precursor gas is supplied at a flow rate of 0.1 to 1.0 g/min.

17. The method according to claim 1, further comprising curing the film deposited on the substrate.

18. The method according to claim 17, further comprising subjecting the cured film to etching, ashing, or wet cleaning.

19. The method according to claim 1, wherein the depositing film on the substrate has a dielectric constant of less than 2.7.
